(19) United States
(12) Patent Application Publication
(10) Pub. No.: US 2022/0058574 A1
(43) Pub. Date: Feb. 24, 2022

(54) Automated Delivery Module for a Crowdfunded Package Subscription Service

(71) Applicant: Leland D. Deehring, Peoria, IL (US)

(72) Inventor: Leland D. Deehring, Peoria, IL (US)

(21) Appl. No.: 17/445,502

(22) Filed: Aug. 20, 2021

Related U.S. Application Data
(60) Provisional application No. 62/706,508, filed on Aug. 21, 2020.

(51) Int. Cl. G06Q 10/08; G06Q 20/40; G06F 16/955

(52) U.S. Cl. CPC G06Q 10/0832; G06F 16/955; G06Q 20/4037; G06Q 10/0838

(57) ABSTRACT

An automated package delivery system and service for crowd-funded package subscription delivery. A recipient creates an account giving delivery information and optionally gives event date(s) for a recipient. Anyone having a unique customer code may submit credit purchases through a graphical user interface, which are transmitted over a network to the delivery system. Multiple packages are delivered to the recipient over a period of time, as long as the recipient's credit balance is greater than a minimum package cost. The contents of the package may automatically change based on the event date(s). The recipient may also provide payment information to top off any deficient credit balances.

### CROSS REFERENCES

This application claims priority of U.S. Provisional Application No. 62/706,508 filed on 21 Aug. 2020.

### FIELD OF THE INVENTION

The present disclosure relates to an automated delivery module for a crowdfunded package subscription service.

### BACKGROUND

Gifting can be stressful. Decisions in making a gift purchase for a friend, family member, or coworker include choosing which item to purchase, when is the proper time to send a gift, avoiding gifts that others are giving, avoiding gifts that the recipient already owns, and selecting a budget for the gift including shipping and taxes.

### SUMMARY

A method of sending deliverables based on subscriptions paid by multiple purchasers who access the purchase information through a graphical user interface with a unique customer code. Delivery information of a recipient is obtained. A unique customer code associated with the recipient is generated. Remote access is provided over a network so anyone can access purchase options for the recipient through a graphical user interface (GUI) with the unique customer code. A credit balance associated with the recipient is tracked by storing credit purchase information from multiple purchasing users submitted through the GUI. A first deliverable is sent if the credit balance is greater than a minimum deliverable cost. Individual confirmation messages are transmitted to the plurality of purchasing users when the first deliverable is sent. Subsequent deliverables are sent to the recipient over a period of time as long as the credit balance remains greater than the minimum deliverable cost.

The recipient may be pregnant. The estimated child delivery date related to a pregnancy of the recipient may be obtained and the estimated child delivery date is stored associated with the expecting recipient. The contents of the first deliverable may relate to the pregnancy of a pregnant recipient. After the first deliverable, subsequent packages may be shipped to the pregnant recipient over a period of time until the estimated child delivery date. if the first package, or any subsequent package, is shipped prior to the estimated child delivery date, the contents may be pregnancy-related. If the first package, or any subsequent package, is shipped after the estimated child delivery date then such package may contain newborn-related contents. A pregnant recipient may send a notification that the baby was born ahead of the estimated child delivery date, and the first package, or any subsequent package, that is shipped after receiving such notice may contain newborn-related contents.

An order slip may be automatically generated when the credit balance exceeds a predefined threshold at a given time for generating a first deliverable or subsequent deliverable. A message may be automatically generated and sent to a plurality of purchasing users upon shipping the package. A message may be automatically generated and sent to the recipient upon shipping the package.

Purchasing users may purchase credits through a graphical user interface (GUI) accessible through the unique identifier, which may be a universal resource locator. The payments are received when users submit their purchases through the GUI. A process tracks a credit balance based on the sum of the plurality of credit purchase amounts from the plurality of purchasing users submitted through the GUI. The processor determines if a credit balance associated with the recipient is greater than a minimum deliverable cost. If the credit balance is greater than a minimum deliverable cost, then an order slip is automatically generated for a first package to the recipient. Individual shipment confirmation messages may be sent to the plurality of purchasing users when the first package ships.

### DESCRIPTION OF THE DRAWINGS

Aspects are illustrated by way of example, and not by way of limitation, in the accompanying drawings, wherein:

FIG. 1 shows a flow chart of a method for sending a subscription of deliverables over a period of time with multiple users purchasing credits toward the subscription;

FIG. 2 shows a flow chart for processing subscription shipments based on credits purchased by a gift buyer with an optional stored subscription creator payment method to generate sufficient credit;

FIG. 3 shows a flow chart of a method for sending a subscription of pregnancy-related and newborn-related deliverables over a period of time with multiple users purchasing credits toward the subscription;

FIG. 4 shows a flow chart of a method for a sending a subscription of deliverables over a period of time with any having access to a unique customer code being able to purchase credits toward the subscription; and

FIG. 5 shows a diagram of a delivery module in network communication with a purchaser computing device and a recipient computing device.

### DETAILED DESCRIPTION

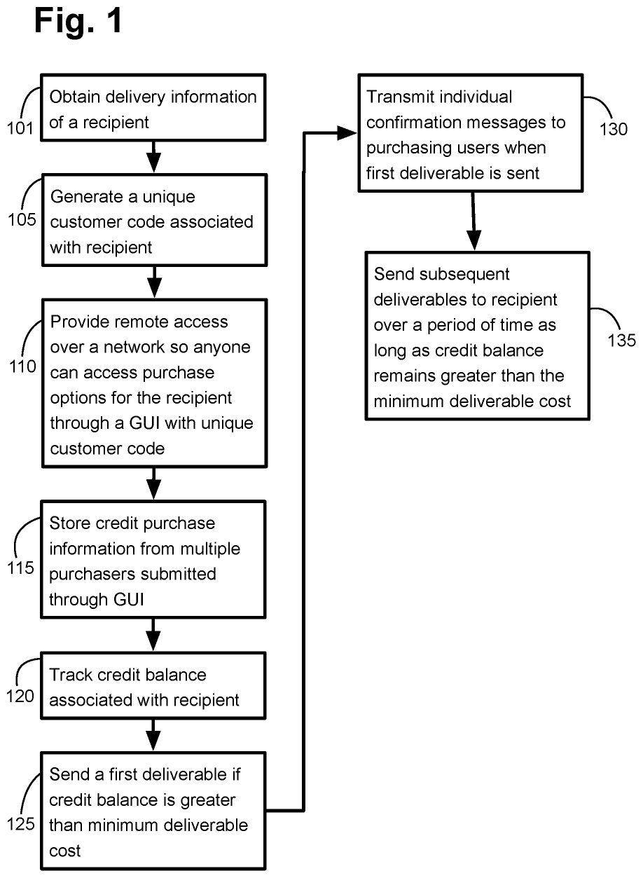

A method for automatically providing a recipient with multiple packages through crowd funding is shown in FIG. 1. Friends, family, or anyone else interested can purchase credits to fund a subscription of deliveries, with each delivery happening as long as there are sufficient credits. These deliveries can be physical deliverables, for example: clothes, toys, food, household goods, parts, equipment, and others. The deliveries can be electronic, for example: subscription renewals, electronic gift cards for certain retailers, or software licenses.

The delivery information of a recipient is obtained, according to step 101. The delivery information may include an account name or number, an email address, a post office box, residential street address, or business street address. The delivery information is stored in a computer accessible database and is identified with the recipient.

A unique customer code is associated with recipient, according to step 105. The unique customer code may be one or more of a universal resource locator (URL), a quick response (QR) code, a bar code, or a unique access code made up of numbers, letters, symbols, or a combination thereof. The unique customer code may be stored in a computer accessible database and identified with the recipient. Multiple unique codes, or identification (ID) numbers, may be associated with the recipient. The unique customer code is designed to be shared. The unique customer code may be shared through social media, email, text messaging, or printed.

The unique customer code is used by purchasers to access credit purchase options, according to step 110. Anyone having the unique customer code can access a graphical user interface (GUI), such as a website or an application, to make a purchase of credits. The credits may be available in units, where each unit corresponds to a minimum deliverable cost or other set purchase price. The customers can pay through credit card transaction or any other electronic payment through the GUI. Users may access the GUI on a variety of user computing device, including computers and other electronic devices, or user mobile computing device, such as phones, tablets and other electronic devices.

The system stores the credit purchase information from multiple purchasing users that were submitted through the GUI, according to step 115. A credit balance associated with the recipient is tracked, according to step 120. That way, each purchase is associated with the intended recipient, increasing the recipient's credit balance.

At a certain interval, a first deliverable is sent if the credit balance is greater than a minimum deliverable cost, according to step 125. The minimum deliverable cost could be associated with a specific product line or category that the recipient has selected. One example discussed below is the situation where the recipient is pregnant. The recipient could indicate the pregnancy, and the minimum deliverable cost would be associated with the packages offered related to maternity or newborn contents.

The system may transmit confirmation messages to each purchasing user when the first deliverable is sent, according to step 130. This message may be found within the GUI or it may be an email message or text message. The message confirms to the user that a deliverable has been sent according to the subscription credits.

Subsequent deliverables are sent to recipient over a period of time, as long as the credit balance associated with the recipient remains greater than the minimum deliverable cost, according to step 135. These subsequent deliverables are sent according to the subscription time interval, which may be weekly, biweekly, monthly, bimonthly, semi-annually, or annually, or another shorter or longer time interval.

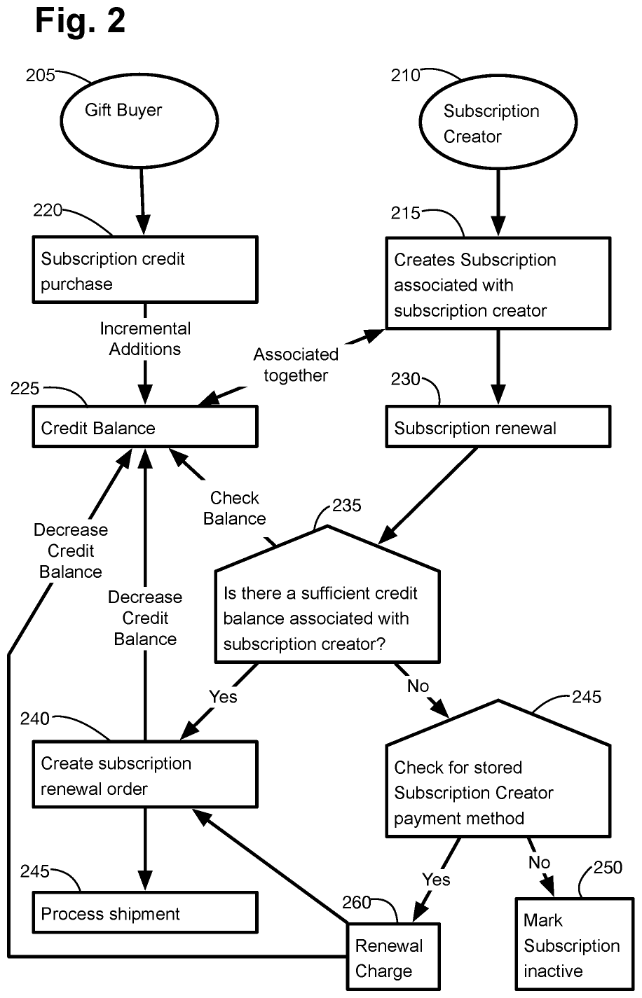

FIG. 2 shows a process for managing subscriptions purchased by multiple gift buyers, where the subscription creator may store a payment method for use if there is insufficient credit generated from gift buyers. A subscription creator 210 creates a subscription associated with that subscription creator, according to step 215. The subscription creator may create the subscription for a specific product or a category of products.

A gift buyer 205 purchases a subscription credit, according to step 220. The subscription credit purchase adds incremental additions to the credit balance 225. A process tracks the incremental additions to the credit balance 225. For example, each time a credit purchase is made, then a database entry is added with the purchase amount associated with the recipient's account. The credit balance 225 is associated with a subscription or with a subscription creator. If the credit balance 225 associated with the subscription creator prior to a subscription renewal is sufficient, then a subscription order will be created, according to step 240. A shipment will then be processed, according to step 245.

The subscription will renew according to a time interval, according to step 230. The time interval may be weekly, biweekly, monthly, bimonthly, semi-annually, or annually, or another shorter or longer time interval. At step 230 for subscription renewal, the credit balance 225 associated with the subscription creator is compared with the minimum deliverable cost to determine if there is sufficient credit, according to step 235. If the credit balance 225 is sufficient, then a subscription renewal order will be created, according to step 240. A shipment will then be processed, according to step 245.

If the credit balance 225 is not sufficient, then the processor will check for a stored subscription creator payment method, according to step 245. If there is a subscription creator payment method associated with the subscription creator, then a renewal charge will be made to the subscription creator payment method, according to step 260. Upon the renewal charge, the credit balance will be decreased. For example, if the minimum ship cost is $50 and the credit balance currently has $25, then a renewal charge will be made of $25. The subscription order will be created, and the credit balance will be reduced to $0. If the credit balance 225 is not sufficient and the subscription creator does not have a stored payment method associated with his or her account, then the subscription will be marked inactive, according to step 250.

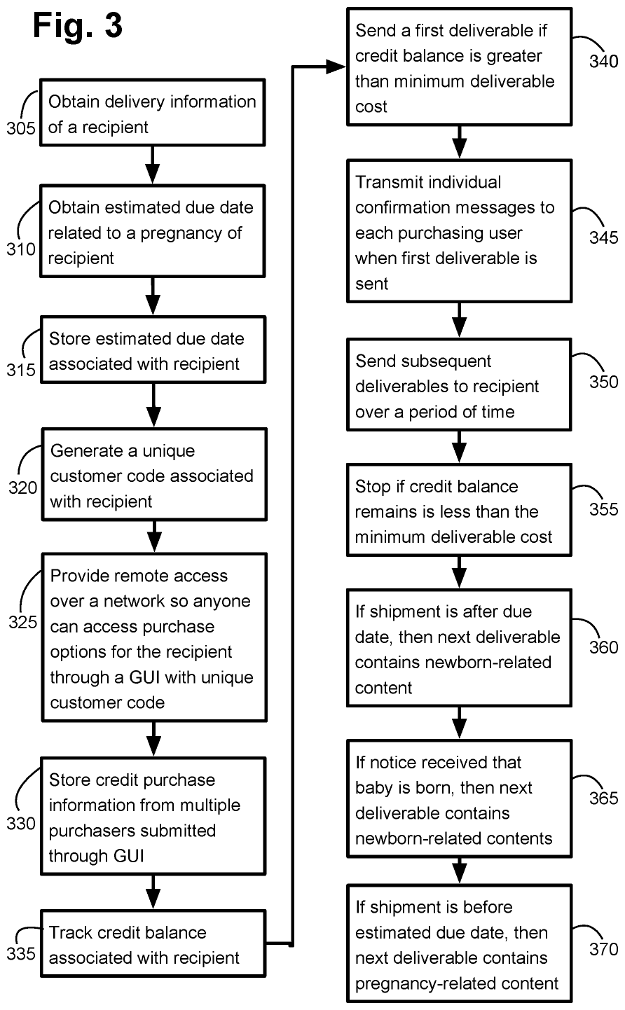

A method for providing a crowd funded, subscription package delivery service to a pregnant recipient is shown in FIG. 3. The delivery information of a recipient who is pregnant is obtained, according to step 305. An estimated child delivery date related to the pregnancy of the recipient is obtained, according to step 310. This information can be obtained through a GUI, such as a website or a mobile app. The information can also be obtained through a phone call, in-person request, or form submission. The estimated child delivery date associated with the recipient is stored, according to step 315. For example, the estimated child delivery date can be entered into a database, associated with a unique user ID. A unique customer code is generated and associated with the recipient, according to step 320. Remote access over a network is provided so anyone can access purchase options for the recipient through a GUI with the unique customer code, according to step 325. Credit purchase information is stored from multiple purchasers, where the credit purchases are submitted through a GUI, according to step 330. The credit purchase information is associated with the recipient using the unique customer code, which may be entered to access the GUI or may be entered into a generic GUI. The credit balance associated with the recipient is tracked, according to step 335. For example, a database is updated with each credit purchase transaction. At a time interval, a first deliverable is sent if the credit balance is greater than a minimum deliverable cost, according to step 340. Individual confirmation messages may be transmitted to each purchasing user when the first deliverable is sent, according to step 345. The confirmation message may contain one or more of a shipping tracking number, an estimated delivery date, a description of the package contents, a list of other purchasers, and a reminder of the estimated child delivery date of the pregnant recipient. Subsequent deliverables may be sent to the recipient over a period of time, according to step 350. If the credit balance remaining is less than a minimum deliverable cost, then the subscription may be stopped and no additional deliverables will be sent, according to step 355.

If a shipment is scheduled after the estimated child delivery date, then the next deliverable may contain newborn-related content(s), according to step 360. If notice is received that the baby has been born, then the next deliverable may contain newborn-related content(s), according to step 365. A GUI may be provided for, or an email may be received by, the recipient to indicate that a child was born prior to the estimated delivery date. In this way, the recipient does not receive maternity-related goods after the child is born. If the shipment is schedule before the estimated child delivery date, and no notice has been received regarding an early delivery of the baby, then the next deliverable may contain pregnancy-related contents, according to step 370.

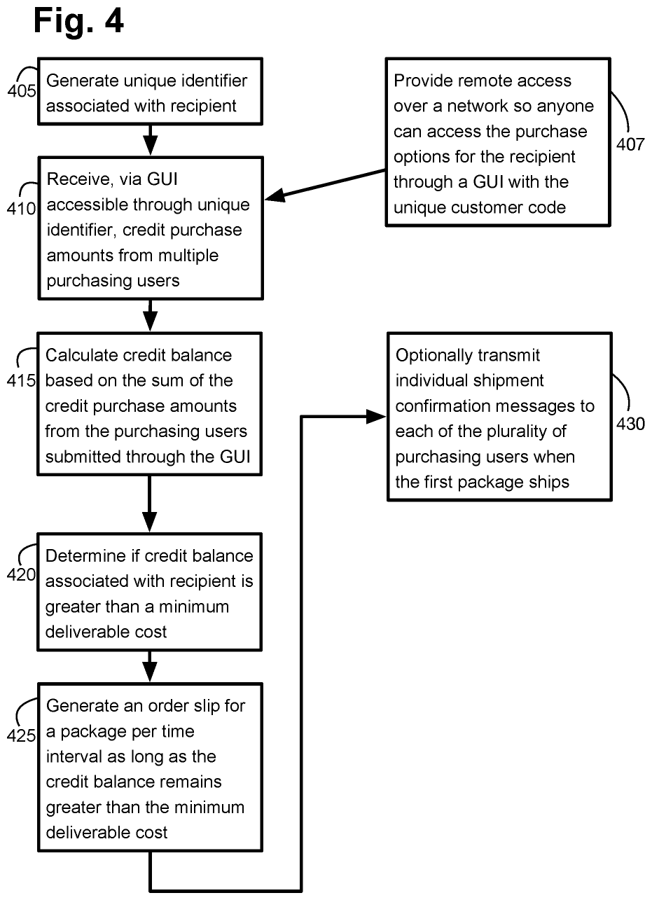

FIG. 4 shows a method for a crowd-funded subscription package service. A unique identifier is generated and associated with the recipient, according to step 405. Remote access is provided over a network, so that anyone can access the purchase options for the recipient through a GUI with the unique customer code, according to step 407. Via a GUI accessible through the unique identifier, credit purchase amounts from multiple purchasing users are received, according to step 410. A credit balance is calculated based on the sum of the credit purchase amounts from the purchasing users, according to step 415. The system determines if the credit balance associated with the recipient is greater than a minimum deliverable cost at a time interval, according to step 420. An order slip for a package is generated at a certain time interval, and this is repeated at a time interval as long as the credit balance remains greater than the minimum deliverable cost, according to step 425. Optionally, an individual shipment confirmation message may be transmitted to each of the purchasing users when a deliverable is shipped, according to step 430.

A crowd-funded, subscription package service can automatically transition from one type of goods to a second type of goods based on an expected event date. For example, a student may receive educational supplies through an expected graduation date. At the graduation date, the goods shipped may relate to a summer vacation. A first-time homeowner could receive various tools for a certain period after closing on a home purchase, and after a determined period of time the deliverables could contain home decoration contents, or vice versa. A grandparent could set up a grandchild as a recipient of gifts at a certain interval, where the gift subscription is configured to grow with the child. The child may receive newborn-related contents in an earlier deliverable, and may receive toddler-related contents in a later deliverable. A crowd-funded, subscription gifting program for readers could send tax-preparation-related reading material in the month of February to help a subscriber prepare for tax returns. A crowd-funded, subscription gifting program for hikers, gardeners, or other outside enthusiasts could vary the deliverable contents based on the seasons. In a time-based, crowd-funded, subscription service, the purchaser is freed from making time-sensitive purchase decisions. The subscription service regulates the timing of the gift delivery, the purchaser is alleviated from the responsibility to properly time a gift or decide on a specific gift by deciding to apply credit to the recipient's subscription account.

An automated package delivery system may comprise a delivery control module. The delivery control module may comprise a first network connection for remote access reception of certain information described above, including, but not limited to, delivery information and an event date for a recipient, and credit purchase details for the recipient accessed through a graphical user interface (GUI) with a unique customer code. The delivery control module contains computer-readable program instructions to associate the delivery information and the event date with a recipient in an electronic database. The delivery control module contains computer-readable program instructions to apply credit purchases from anyone entering a unique customer code to the account of the recipient associated with the unique customer code. The delivery control module contains computer-readable program instructions to automatically generate an order slip having a delivery date for a package for delivery to the recipient over a period of time. The period of time can be one or more days, one week, two weeks, six weeks, one month, two months, three months, every trimester of a pregnancy, semi-annually, annually (such as on a birthday, anniversary, or other specified date or holiday), or other time frames. The delivery control module contains computer-readable program instructions to automatically change content designations of the multiple packages based on whether the delivery date occurs before or after the event date. The delivery control module may also contain computer-readable program instructions to track a credit balance associated with the recipient by storing a plurality of credit purchase information from a plurality of purchasing users submitted through the GUI. The delivery control module may also contain computer-readable program instructions to determine if a credit balance associated with the recipient is greater than a minimum package cost, where the credit balance is based on a sum of the plurality of credit purchases from the plurality of purchasing users submitted through the GUI and automatically generate an order slip for a package per time interval as long as the credit balance remains greater than the minimum package cost. The automated package delivery system may also comprise a user computing device associated with a first purchasing user. The user computing device comprises a processor communicatively coupled to a storage device and a network connection. The user computing device executes application code instructions that are stored in the storage device to cause the system to display the GUI and transmits, using the network connection, to the delivery control module a first credit purchase using the unique customer code.

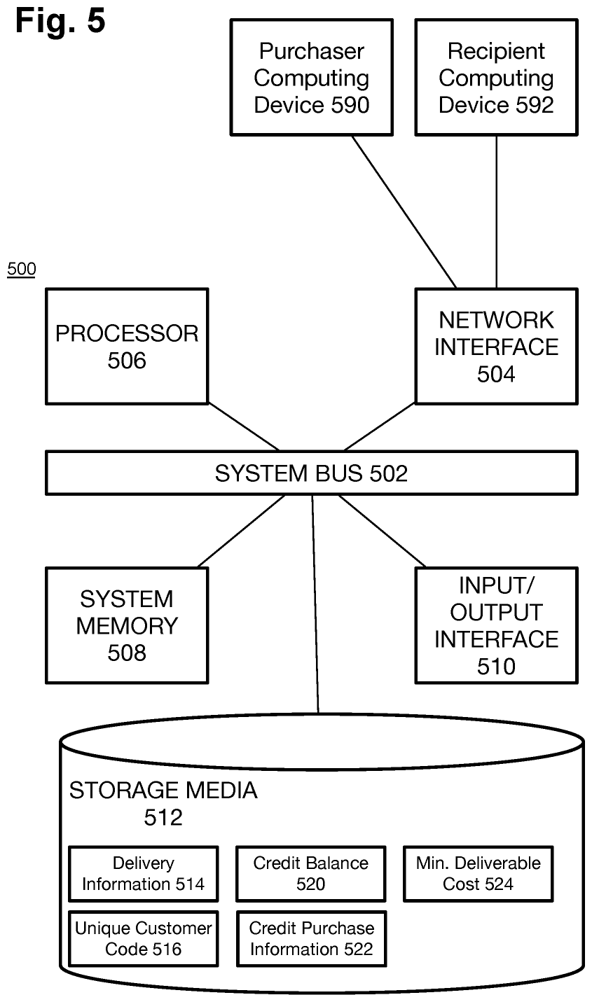

As shown in FIG. 5, a system may include multiple computer systems. Delivery control module 500 may include a system bus 502 connecting a network interface 504, processor 506, system memory 508, input/output interface 510, and storage media 512. Instructions for the methods and processes described may be embedded in at least one non-transitory computer-readable storage medium. These instructions may be executed by a processor 506, such as a central processing unit, via computer readable memory. The at least one computer performs the methods discussed above. The term “non-transitory”, as used herein, is a limitation of the medium itself (i.e., tangible, not a signal) as opposed to a limitation on data storage persistency (e.g., Random-access memory (RAM) vs. Read-only memory (ROM)). Using the network interface 504, the delivery module 500 may communicate with a purchaser computing device 590 and the recipient computing device 592. Each of the purchaser computing device 590 and the recipient computing device 592 may have similar processor, bus, network interface, storage media, system memory, and input/output interface as the delivery module. The storage media 512 may include one or more databases of information including delivery information 514 in the form of addresses and instructions, a unique customer code 516 for each recipient, a credit balance 520 for each recipient, credit purchase information 522 for each purchaser associated with one or more recipients, and a minimum deliverable cost 524 which may include a product cost, product category, product type, shipping cost, handling cost, tax, and other transaction related cost information.

A computer or microprocessor may be programmed to run the above listed instructions, carrying out the above-described algorithms. A delivery control module 500 could be a server, desktop computer, laptop computer, tablet device, smart phone, handheld computer, or any other wired or wireless, processor-driven device.

The above-described processes may be software in the form of one or more software modules. Software modules may be executable code in various forms, including: executable application, an Application Programming Interface (API), a subroutine, a function, a procedure, an applet, a servlet, a routine, source code, object code, a shared library/dynamic load library or one or more instructions. Software modules may be stored in any type of suitable non-transitory or transitory storage medium (e.g., electrical, optical, acoustical or other form of propagated signals, such as carrier waves, infrared signals, or digital signals).

We claim:

1. A computer-implemented method to automate package deliveries comprising the steps of:
by one or more computing devices: (a) generating a database having a customer code associated with a recipient; (b) providing remote access over a network so anyone can access purchase options for the recipient through a graphical user interface (GUI) with the customer code; (c) tracking a credit balance associated with the recipient by storing a plurality of credit purchase information from a plurality of purchasing users submitted through the GUI; and generating, iteratively over a period of time, subsequent order slips for subsequent deliverables addressed to the recipient as long as the credit balance remains greater than a minimum deliverable cost.

2. The method of claim 1, where the recipient is pregnant, and a deliverable relates to a pregnancy.

3. The method of claim 1, further comprising the step of:
a. obtaining an estimated child delivery date related to a pregnancy of the recipient; and
b. storing the estimated child delivery date associated with the recipient.

4. The method of claim 3, further comprising the step of:
a. shipping subsequent deliverables to the recipient over a period of time until the estimated child delivery date.

5. The method of claim 4, where a deliverable shipped prior to the estimated child delivery date contains pregnancy-related contents.

6. The method of claim 5, where the deliverable shipped after the estimated child delivery date contains newborn-related contents.

7. The method of claim 1, further comprising the step of:
a. automatically generating an order slip when the credit balance exceeds a predefined threshold.

8. The method of claim 3, further comprising the steps of:
a. receiving notification that a baby was born ahead of the estimated child delivery date; and
b. shipping a deliverable containing newborn-related contents.

9. The method of claim 1, further comprising the step of:
a. transmitting a message to the plurality of purchasing users upon shipping a deliverable.

10. A non-transitory computer-readable storage medium having data stored therein representing software executable by a computer, the software comprising instructions for:
a. associating a unique identifier associated with a recipient;
b. receiving, via a graphical user interface (GUI) accessible through the unique identifier, a plurality of credit purchase amounts from a plurality of purchasing users;
c. determining if a credit balance associated with the recipient is greater than a minimum deliverable cost, where the credit balance is based on a sum of the plurality of credit purchase amounts from the plurality of purchasing users submitted through the GUI; and
d. automatically generating an order slip for a package per time interval as long as the credit balance remains greater than the minimum deliverable cost.

11. The non-transitory computer-readable storage medium of claim 10, further comprising instructions for:
a. transmitting individual confirmation messages to the plurality of purchasing users when a first package ships.

12. The non-transitory computer-readable storage medium of claim 10, where the unique identifier is a universal resource locator.

13. The non-transitory computer-readable storage medium of claim 10, further comprising instructions for:
a. providing remote access over a network so anyone can access purchase options for the recipient through the GUI with the unique identifier.

14. The non-transitory computer-readable storage medium of claim 10, further comprising instructions for:
a. obtaining an estimated child delivery date related to a pregnancy of the recipient; and
b. storing the estimated child delivery date associated with the recipient.

15. The non-transitory computer-readable storage medium of claim 14, where the instruction of automatically generating the order slip for the package per time interval ends at the earlier of (1) the credit balance remains greater than the minimum deliverable cost and (2) the estimated child delivery date.

16. The non-transitory computer-readable storage medium of claim 14, where the order slip generated has a shipping date that is prior to the estimated child delivery date and contains pregnancy-related contents.

17. The non-transitory computer-readable storage medium of claim 14, further comprising instructions for:
a. generating a second order slip for a second package containing newborn-related contents for delivery to the recipient after the estimated child delivery date.

18. The non-transitory computer-readable storage medium of claim 14, further comprising instructions for:
a. receiving notification that a baby was born ahead of the estimated child delivery date; and
b. generating a second order slip for a subsequent package containing newborn-related contents.

19. An automated package delivery system comprising:
a. a delivery control module comprising:
i. a first network connection for remote access reception of:
delivery information and an event date for a recipient;
credit purchase details for the recipient accessed through a graphical user interface (GUI) with a customer code;
b. wherein the delivery control module is operable to:
i. associate the delivery information and the event date with a recipient in an electronic database;
ii. apply a first credit purchase from anyone entering the customer code to the account of the recipient associated with the customer code;
iii. automatically generate an order slip having a delivery date for a package for delivery to the recipient over a period of time; and
iv. automatically change content designations of the multiple packages based on whether the delivery date occurs before or after the event date.

20. The automated package delivery system of claim 19, wherein the delivery control module is further operable to:
a. track a credit balance associated with the recipient by storing a plurality of credit purchase information from a plurality of purchasing users submitted through the GUI.

21. The automated package delivery system of claim 19, wherein the delivery control module is further operable to:
a. determine, by a processor, if a credit balance associated with the recipient is greater than a minimum package cost, where the credit balance is based on a sum of a plurality of credit purchases from a plurality of purchasing users submitted through the GUI; and
b. automatically generate an order slip for a package per time interval as long as the credit balance remains greater than the minimum package cost.

22. The automated package delivery system of claim 19 further comprising:
a. a purchaser computing device associated with a first purchasing user, the purchaser computing device comprising a processor communicatively coupled to a storage device and a second network connection, wherein the purchaser computing device executes application code instructions that are stored in the storage device to cause the automated package delivery system to display the GUI and transmits, using the second network connection, to the delivery control module a first credit purchase using the customer code.
